(19) United States
(12) Patent Application Publication
(10) Pub. No.: US 2010/0038418 A1
(43) Pub. Date: Feb. 18, 2010

(54) METHOD FOR BIOMETRIC AUTHORIZATION FOR FINANCIAL TRANSACTIONS

(76) Inventors: George I. Fomitchev, Moscow (RU); Max I. Fomitchev, State College, PA (US); Tatyana Zamilova, Smolensk (RU)

Correspondence Address: Max Fomitchev, 861 Willard Street, State College, PA, 16803, US

(21) Appl. No.: 12/193,347

(22) Filed: Aug. 18, 2008

(51) Int. Cl. G06Q 40/00

(52) U.S. Cl. 235/379

(57) ABSTRACT

This invention comprises a method of biometric authorization for making secure financial transactions via bank card (magnetic or smart). All or portion of the personal and financial information on the said bank card is encrypted and is not available without a decoding key that is calculated using the card owner's biometric data. To decode the said information and gain access to the financial data the card's owner needs to prove his/hers identify by providing the required biometric data (e.g. place finger on fingerprint scanner). The captured fingerprint is then converted into a key that is used to decode said encrypted information. Incorrect fingerprint will produce an invalid key that will not succeed at decoding of the encrypted information. The decoding of said information may take place locally at the merchant's point of sale device or remotely at the card issuer's server. This kind of electronic authorization has a high level of security and thus reduces the risks and costs incurred by the card issuer due to monetary losses associated with fraudulent transactions made possible by unauthorized capturing (e.g. snooping) of financial information, theft, or loss of the bank card itself.

### BACKGROUND

1. Field of the Invention

This invention relates to a secure (online or offline) method of biometric authorization for financial transactions involving the reading and possibly the transmission of financial information obtained from bank card (magnetic or smart).

2. Description of Prior Art

Financial transactions involving bank cards (e.g. credit or debit cards) are processed routinely by financial institutions and require proper authorization to ensure authenticity of charges. Improper or weak authorization results in monetary losses to financial institutions due to fraudulent transactions or hijacked financial information. Recently biometric authorization has been called for to improve the security of such transactions.

For example there is a system for authorizing a check cashing transaction between a consumer and a merchant using identity verification based on biometric information. A system comprises a central biometric information database containing biometric and personal identity-verifying data registered therein by a consumer and containing merchant identity-verifying data registered therein by a merchant. The system further comprises a merchant local device having a biometric reader and linked via a network to the central biometric information database. Using the biometric reader, a consumer desiring to cash a check presents biometric data to the central biometric information database via the biometric reader. The central biometric information database provides an electronic comparison of the present biometric data with the biometric data registered by the consumer. If the presented data and the registered data match, an approval signal is transmitted to the merchant's local device (U.S. Pat. No. 6,957,770).

There is also a method for providing biometric authorization of a card holder comprising reading of bank card (e.g. smart card) information and a finger print of the card owner and matching it on the computer host system, or on an intelligent smart card reader, or on the card itself via match on card (MOC) method: http://www.cardwerk.com/smart-card-readers/fingerprintscanner.aspx. In this method biometrics adds an additional layer of security to a smart card system. A biometric smart card protects biometric data. The method claims that the fingerprints are an ideal credential for logical access control to computer networks and fingerprint templates never leave a smart card unprotected. Smart cards are ideal to store fingerprint templates, make them portable and validate the identity of the card holder. In case of a “match on a card” system, they stay inside the card from the time of first enrollment.

The main disadvantage of these and other methods and systems is that financial and personal information is also embossed and stored on the bank card and it is not protected against theft during the transaction itself (the stolen financial information can be used later to initiate unauthorized charges on behalf of the card owner). Moreover, fingerprint images of card owners stored at a central database are typically not protected either beyond usual enterprise security systems. These mentioned disadvantages may lead to security and monetary risks to financial institutions due to transaction snooping (during the transaction), physical credit card theft or database hacking. Thus despite the mentioned advances in security it is still desirable to protect bank account numbers and other pertinent financial information of bank card owner as well as their personal and biometric data against snooping, theft or unauthorized capture that lead to unauthorized usage.

### OBJECTS AND ADVANTAGES

Given the above-described vulnerabilities associated with the use of conventional bank cards (magnetic or smart) we present a new and more secure method for financial transaction processing and bank card and authorization.

One of the main aspects of the present invention is to provide consumers with a convenient way of identifying themselves that doesn't require them to remember any PIN codes, password or present any kind of tokens during transaction that can be compromised or forgotten.

It is also an aspect of the present invention to protect financial, personal and biometric information of the card holder from theft and unauthorized use.

Another aspect of the present invention is that it allows merchants to confirm the identity of the consumer desiring to make a purchase using only a bank card and their fingerprint scan.

Yet another aspect of the present invention is to provide a bank card and a method for authorization of financial transactions that is more convenient and secure, and easy to use for both the merchant and the consumer when compared with other currently available methods.

Reduction of financial loss of a customer due to unauthorized usage of their bank, personal and biometric data is also an aspect of the present invention.

Another aspect of the present invention is that it allows consumers to make transactions at a remote device or locally at a merchant's point of sale device, as well as online while making purchase on the Internet.

### DRAWING FIGURES

FIG. 1 illustrates the enrollment process.

FIG. 2 illustrates data entry process.

FIG. 3 illustrates transmission and matching process.

FIG. 4 illustrated data encoding process.

### DETAILED DESCRIPTION OF THE EMBODIMENTS

The present invention may be embodied as a method for authorization of financial transactions using biometric information. The method comprises an enrollment process and a transaction handling process.

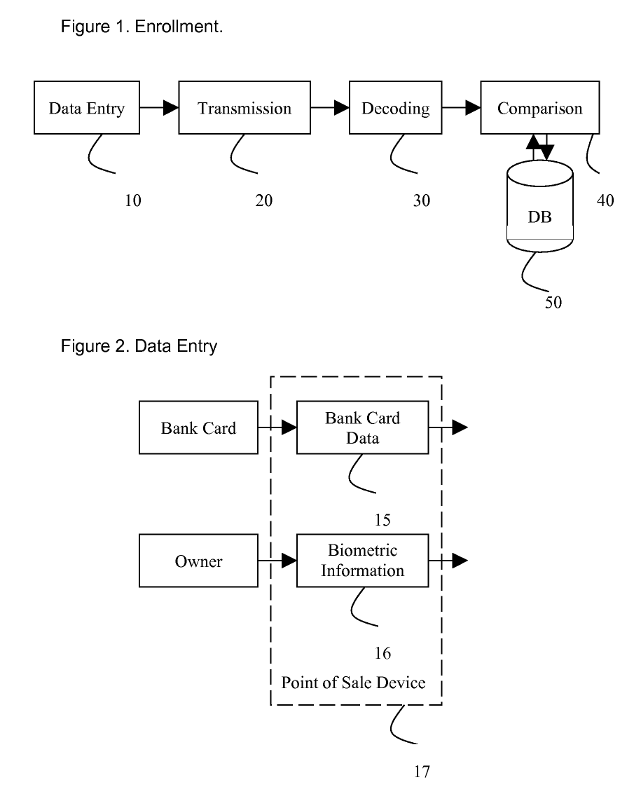

The enrollment method—FIG. 1—Includes data entry (10), transmission of data (20), its decoding (30) and comparison (40) of the encoded message to that stored in the central financial database (50).

The data entry portion—FIG. 2—comprises simultaneous reading of bank card data (15) and biometric information (16) of the card holder at a local (merchant's) device (17).

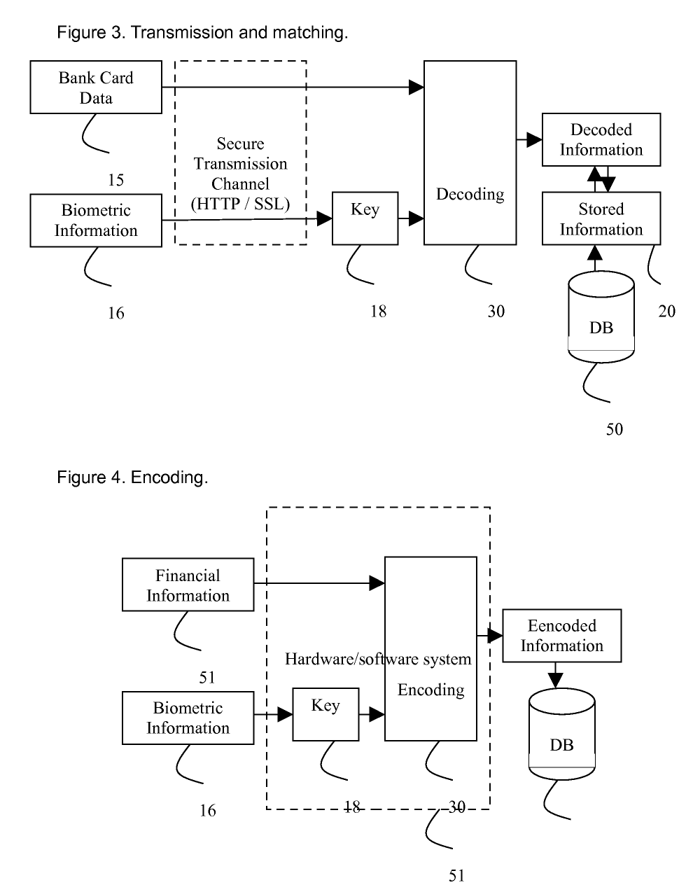

The next step is the transmission—FIG. 3—of the bank card data (15) (which is encrypted) and the biometric information (16) to the bank's database (50), its decoding there using the key (18) constructed from the biometric information, and comparison of the decoded information (19) to the one stored in the bank's database (20). If the decoded information and matches the one previously registered in the bank's database, the consumer's enrollment is accepted.

Decoding of the encrypted bank card information is also possible at a local merchant's device if it is equipped with the decoding program. In this case the decoded financial and personal data is transmitted to the central bank database for checking. If the decoded information matches that in the central bank database the process of enrollment is finished and financial transactions may begin.

As noted above, the present invention encompasses a method for authorization of a financial transaction using a bank card with encrypted personal and financial information and a biometric scan as the key to decoding said information.

A detailed description of the present invention follows below to provide a fuller exposition of additional features of the invention as it is implemented in various forms.

It is important to understand that the invention is not limited in its application to the details of the arrangements of the components shown in the following description. The invention is capable of other embodiments and of being carried out in various ways. Also, it is to be understood that the phraseology and terminology employed herein are for the purposes of description and should not be construed as limiting.

It is important, therefore, that the claims be regarded as including such equivalent constructions insofar as they do not depart from the spirit and scope of the present invention.

The main aspect of the embodiment of the invention—FIG. 4—Is the central database (50) (e.g. bank's or card issuer database) equipped with hardware/software system (51) for reading live biometric data (16) (e.g. fingerprint scan) and encoding personal and financial information (52) of a bank card holder using the encryption key obtained from the said live biometric data. For this purpose it is possible to use any fingerprint scanners (e.g. the one produced by SecuGen) and the software developed by the authors of this invention (www.biometriccards.magistre.ru).

Thus when a customer orders a bank card in a bank or any other financial institution authorities to issue bank cards (hereinafter the bank), a customer along with their personal data must presents their live biometric data (for purpose of illustration and without any limitation we will discuss here a fingerprint) by placing one of their fingers on a biometric reading device (fingerprint scanner). In this case a customer must remember what finger to use as the key for their authorization for financial transactions. The received biometrics will be used by the card issuer for encoding personal and financial information of the customer to be recorded onto their bank card. After that a customer's biometrics will be deleted from the server of the bank card issuer.

To encode a customer's personal and financial information via their biometrics for their bank card the card issuer uses the original software developed by the authors of the present invention where the biometric data of a customer are expressed as a binary 128 to 512 byte key. When a customer's card is ready their biometric data is deleted from the bank server and are not stored there and thus cannot be a subject to theft. The encoded financial and personal information of a customer is stored in the central bank database. The name, bank account and other pertinent financial data of the customer is stored in the card also in encrypted form and thus can be retrieved if and only if a live biometrics of the card holder is presented. The card has no name, account number or any other personal information of its holder embossed on it in order to prevent usage of this information when the card is lost, stolen or handled.

The encrypted bank card may be used for financial transactions both online, on the Internet, or at the merchant station.

For making transactions online, a card holder's personal or laptop computer should be equipped with a card-reader and biometric scanner (fingerprint reader), as well as special software (e.g. the one developed by the authors of the present invention, www.biometriccards.magistre.ru) for decoding the encrypted information read from the card. However, the outfitting the customer's computer with the said special software is optional since the decoding of the encrypted financial information can be performed remotely at the transaction processing server.

To make a purchase online or perform any other financial transaction using a computer customer should insert the encrypted bank card into a card reader and place a finger on a fingerprint scanner. If the encrypted financial information read from the card is successfully decrypted using the captured fingerprint scan the software can initiated the requested financial transaction. Decoding of the encrypted financial information can occur locally or remotely; in both cases the transmission of financial information across the Internet should proceed via a secure channel (e.g. HTTP SSL).

The above-described embodiments of the present invention provide easy integration of the invention with existing financial data processing devices such as point-of-sale devices (including specially outfitted computers), commercial fingerprint scanners (built-in or stand alone), industry standard smart cards (including magnetic cards), and standard communication channels.

### CONCLUSION, RAMIFICATIONS, AND SCOPE

The main benefit of the present invention is improved security of financial transactions that are initiated online or at point-of-sale devices. The improved security is provided by the encryption of sensitive personal and financial information with a key calculated based off the card owner's live biometric data. As an added benefit for the owner the method does not require memorization of passwords or PIN codes that can be compromised or forgotten. Finally, the removal of visually imprinted financial and personal information from the bank card further improves security as renders the card absolutely useless in the event of theft or loss. As a result both consumers and card issuers stand to benefit both in their experience and materially due to improved security offered by the hereby disclosed invention.

It will be appreciated that numerous modifications of the embodiments described can be effected within the scope of this invention.

What is claimed is:

1. A method for biometric authorization for financial transactions, comprising: receiving financial information from the owner of the bank card and along with their biometric data.

2. The method of claim 1, wherein said financial information is encrypted and is not available without the decoding key.

3. The method of claim 2, wherein the key to decoding of said encrypted financial information is obtained from the card owner's live biometric data.

4. The method of claim 3, wherein said biometric data is the owner's fingerprint scan.

5. The method of claim 2, wherein decoding of said encrypted financial information is performed at the moment of processing of the financial transaction.

6. The method of claim 5, wherein decoding of said financial information is performed either locally at the merchant point of sale device or remotely at the card issuer's server.
